(19) United States
(12) Patent Application Publication
(10) Pub. No.: US 2025/0232356 A1
(43) Pub. Date: Jul. 17, 2025

(54) SYSTEM AND METHOD FOR GENERATING COHESIVE PRODUCT RECOMMENDATION SETS AND VARIANTS

(71) Applicant: Walmart Apollo, LLC, Bentonville, AR (US)

(72) Inventors: Morteza Farrokhsiar, San Francisco, CA (US); Najmeh Forouzandehmehr, Sunnyvale, CA (US); Ramin Giahi, Rego Park, NY (US); Evren Korpeoglu, San Jose, CA (US); Haribani Sangeeta Malhotra, Burlingame, CA (US); Quint Barr, Sunnyvale, CA (US); Kannan Achan, Saratoga, CA (US)

(21) Appl. No.: 19/014,715

(22) Filed: Jan. 9, 2025

Related U.S. Application Data
(60) Provisional application No. 63/620,634, filed on Jan. 12, 2024.

(51) Int. Cl. G06Q 30/0601; G06F 40/20; G06Q 30/0282

(52) U.S. Cl. CPC G06Q 30/0631; G06F 40/20; G06Q 30/0282; G06Q 30/0643

(57) ABSTRACT

System and methods for generating cohesive product recommendations and variants are disclosed. In some embodiments, a disclosed method includes: storing, in a database, historical customer data associated with a customer, receiving, from a user interface, an indication of a customer's selection of a first product, parsing and extracting complimentary product type data from product data stored within the database, the complimentary product type data associated with the first product and including a plurality of product types, and generating look data based on the historical customer data, the complimentary product type data, and the first product, the look data including the first product and a plurality of different products each from a different product type of the plurality of product types.

### CROSS-REFERENCE TO RELATED APPLICATION

This application claims benefit to U.S. Provisional Application Ser. No. 63/620,634, entitled “System and Method for Generating Cohesive Product Recommendation Sets and Variants,” filed on Jan. 12, 2024, the disclosure of which is incorporated herein by reference in its entirety.

### TECHNICAL FIELD

This application relates generally to managing retail products and, more particularly, to systems and methods for generating cohesive product recommendation sets and variants.

### BACKGROUND

Retailers on consistently providing recommendations of products to customers using an e-commerce platform. For example, customers looking for specific products can be provided with other products for purchase. Retailers present recommended products to increase the amount that a customer purchases. This results in increase sales of products, overall gross merchandise value (GMV) and overall revenue for the retailer. However, retailers face difficulties determining which products to offer to the customer that will result in the customer purchasing an additional product.

Current methods of recommending products to a customer include looking through a database or catalog of products and identifying similar products. For example, a customer searching for a shirt may be provided other similar shirts as recommended products for purchase. However, the customer may require pants or accessories for matching with the shirt. Current methods are not specific to the customer nor do they provide any cohesive look to the customer or variants of specific looks.

### SUMMARY

The embodiments described herein are directed to systems and methods for generating cohesive product recommendation sets and variants.

In various embodiments, a system including a database storing historical customer data associated with a customer, a computing device comprising at least one processor in communication with the database, the computing device being configured to receive, from a user interface, an indication of a customer's selection of a first product, parse and extract complimentary product type data from product data stored within the database, the complimentary product type data associated with the first product and including a plurality of product types, and generate look data based on the historical customer data, the complimentary product type data, and the first product, the look data including the first product and a plurality of different products each from a different product type of the plurality of product types.

In various embodiments, a computer-implemented method is disclosed. The computer-implemented method includes storing, in a database, historical customer data associated with a customer, receiving, from a user interface, an indication of a customer's selection of a first product, parsing and extracting complimentary product type data from product data stored within the database, the complimentary product type data associated with the first product and including a plurality of product types, and generating look data based on the historical customer data, the complimentary product type data, and the first product, the look data including the first product and a plurality of different products each from a different product type of the plurality of product types.

In various embodiments, a non-transitory computer readable medium having instructions stored thereon is disclosed. The instructions, when executed by at least one processor, cause at least one device to perform operations including: storing, in a database, historical customer data associated with a customer, receiving, from a user interface, an indication of a customer's selection of a first product, parsing and extracting complimentary product type data from product data stored within the database, the complimentary product type data associated with the first product and including a plurality of product types, and generating look data based on the historical customer data, the complimentary product type data, and the first product, the look data including the first product and a plurality of different products each from a different product type of the plurality of product types.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a network environment configured to generate cohesive product recommendation sets and variants, in accordance with some embodiments of the present teaching.

FIG. 2 is a block diagram of a recommendation engine, in accordance with some embodiments of the present teaching.

FIG. 3 is a flow diagram of a system for generating cohesive product recommendation sets and variants, in accordance with some embodiments of the present teaching.

FIG. 4 is a flow diagram of an exemplary model for generating cohesive product recommendations used by the system of FIG. 3, in accordance with some embodiments of the present teaching.

FIG. 5 is a flow diagram of a recommendation engine of the system for generating variant cohesive sets, in accordance with some embodiments of the present teaching.

FIG. 6 is a flowchart illustrating an exemplary method for generating cohesive product recommendation sets and variants, in accordance with some embodiments of the present teaching.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

The present disclosure provides systems and methods for generating cohesive product recommendation sets and variants. In some embodiments, the systems and methods utilize models (e.g., machine learning models) to generate cohesive product recommendations. For example, the systems and method provided herein may generate recommendations for one or more products (e.g., items) based off an initial product. The recommendations may include one or more products that are related to the initial product (e.g., that are cohesive), but are a different product type. The recommendations may complete a certain outfit, such as a fashion clothing outfit.

In some embodiments, the recommendations include a plurality of different product in a plurality of different product types. The systems and methods provided herein may generate multiple outfits based on the recommendations. In some embodiments, using one or more models, the multiple outfits are determined as being a cohesive look (e.g., matching) and multiple cohesive outfits are generated. The multiple cohesive outfits may be ranked based on historical transaction data associated with the customer. In some embodiments, the systems and methods provided herein generate variant outfits that are similar to the cohesive outfits.

One goal of the present teaching is to generate a complete, stylized, cohesive outfit built around an initial product (e.g., anchor product) that the customer is interacting with on a web page of e-commerce platform. In some embodiments, a disclosed system utilizes one or more models to generate cohesive outfits and variants specific to the customer. The system can display these for the customer via a user interface.

In some embodiments, the system includes a user interface to provide the customer one or more cohesive outfits. The user interface may also provide to the user a variants of the cohesive outfits. In some embodiments, the variants of the cohesive outfits includes variant anchor products. For example, a customer may select a first anchor product and the systems and methods provided herein may generate a cohesive outfit around the first product. The systems and methods provided herein may also generate a second anchor product and generate one or more cohesive outfits around the second product.

In some embodiments, the system includes a user interface to provide the product recommendations to the customer that form a cohesive look or outfit. As used throughout herein, the term look or outfit refers to a plurality of clothing items that match and provide a cohesive visual appearance. The user interface may provide a plurality of recommended products of different product types that complete a cohesive look with the anchor product. In some embodiments, the system automatically generates the plurality of products in the specific arrangement for display to the user via the user interface. The user may interact with the user interface to select one or more of the plurality of recommended products for purchase.

Furthermore, in the following, various embodiments are described with respect to methods and systems for generating cohesive product recommendation sets and variants. In some embodiments, a disclosed method includes: storing, in a database, historical customer data associated with a customer, receiving, from a user interface, an indication of a customer's selection of a first product, parsing and extracting complimentary product type data from product data stored within the database, the complimentary product type data associated with the first product and including a plurality of product types, and generating look data based on the historical customer data, the complimentary product type data, and the first product, the look data including the first product and a plurality of different products each from a different product type of the plurality of product types.

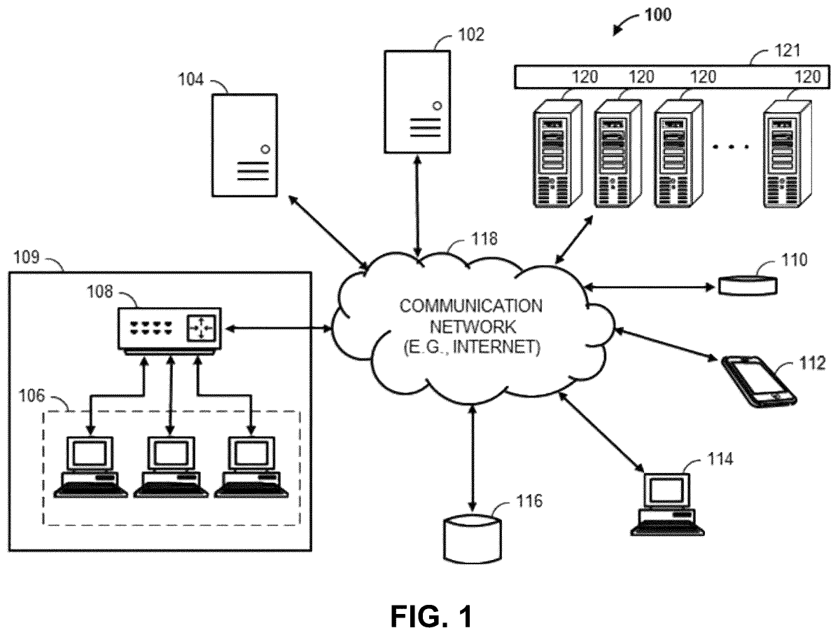

Turning to the drawings, FIG. 1 is a network environment 100 configured to generate cohesive product recommendations and variants, in accordance with some embodiments of the present teaching. The network environment 100 includes a plurality of devices or systems configured to communicate over one or more network channels, illustrated as a network cloud 118. For example, in various embodiments, the network environment 100 can include, but not limited to, recommendation engine 102 (e.g., a server, such as an application server), a web server 104, a cloud-based engine 121 including one or more processing devices 120, workstation(s) 106, a database 116, and one or more user computing devices 110, 112, 114 operatively coupled over the network 118. The recommendation engine 102, the web server 104, the workstation(s) 106, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the recommendation engine 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the recommendation engine 102.

In some examples, each of the multiple user computing devices 110, 112, 114 can be a cellular phone, a smart phone, a tablet, a personal assistant device, a voice assistant device, a digital assistant, a laptop, a computer, or any other suitable device. In some examples, the web server 104 hosts one or more retailer websites providing one or more products or services. In some examples, the recommendation engine 102, the processing devices 120, and/or the web server 104 are operated by a retailer. The multiple user computing devices 110, 112, 114 may be operated by customers or advertisers associated with the retailer websites. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at a store 109 of a retailer, for example. The workstation(s) 106 can communicate with the recommendation engine 102 over the communication network 118. The workstation(s) 106 may send data to, and receive data from, the recommendation engine 102. For example, the workstation(s) 106 may transmit data identifying items purchased by a customer at the store 109 to the recommendation engine 102.

Although FIG. 1 illustrates three user computing devices 110, 112, 114, the network environment 100 can include any number of user computing devices 110, 112, 114. Similarly, the network environment 100 can include any number of the recommendation engine 102, the processing devices 120, the workstations 106, the web servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In some embodiments, each of the first user computing device 110, the second user computing device 112, and the Nth user computing device 114 may communicate with the web server 104 over the communication network 118. For example, each of the multiple computing devices 110, 112, 114 may be operable to view, access, and interact with a website, such as a retailer's website hosted by the web server 104. The web server 104 may transmit user session data related to a customer's activity (e.g., interactions) on the website.

In some examples, a customer may operate one of the user computing devices 110, 112, 114 to initiate a web browser that is directed to the website hosted by the web server 104. The customer may, via the web browser, view a user interface for viewing and interacting with an anchor product (e.g., anchor item) and cohesive product recommendations generated by recommendation engine 102. The website may capture these activities as user session data, and transmit the user session data to the recommendation engine 102 over the communication network 118. The website, via the user interface, may also allow the user to view and interact with an anchor product and one or more products recommended to the user by the recommendation engine 102. In some examples, the web server 104 transmits user data to the recommendation engine 102. The user data may include data associated with the user's interaction with the website via the user interface.

In some examples, a user (e.g., a customer) may use one of the user computing devices 110, 112, 114 to view and interact act with one or more products recommended by the recommendation engine 102. The user may use a user interface to view and purchase products via web server 104. The user may, via the web browser or the user interface, view and interact with one or more products. The website may capture at least some of these activities as user data. The web server 104 may transmit the user data to the recommendation engine 102 over the communication network 118, and/or store the user data to the database 116.

In some embodiments, the web server 104 transmits a recommendation request to the recommendation engine 102, e.g. based on a customer's interaction. For example, the recommendation request may be sent based on a user adding one or more items (e.g., anchor product) to their cart on an e-commerce platform. The recommendation request may be sent standalone or together with other related data of the website. In some examples, the recommendation request may carry or indicate user data.

In some examples, the recommendation engine 102 may execute one or more models (e.g., algorithms), such as a mathematical models, machine learning model, deep learning model, statistical model, etc., to generate and implement markdowns for one or more products. The recommendation engine 102 may generate one or more products for purchase by a customer for maximizing GMV associated with the user.

The recommendation engine 102 is further operable to communicate with the database 116 over the communication network 118. For example, the recommendation engine 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the recommendation engine 102, in some examples, the database 116 can be a local storage device, such as a hard drive, a non-volatile memory, or a USB stick. The recommendation engine 102 may store historical data, business metrics, user data, or data associated with one or more products received from the web server 104 in the database 116. The recommendation engine 102 may receive customer data (e.g., customer historical data). The recommendation engine 102 may also receive from the web server 104 user session data identifying events associated with browsing sessions, and may store the user session data in the database 116. Database 116 may be coupled to a computing device. For example, database 116 may be coupled to one or more user computing devices 110, 112, 114 via communication network 118.

In some embodiments, the web server 104 transmits a model training request to the recommendation engine 102. Upon the model training request, the recommendation engine 102 may retrieve, e.g. from the database 116, historical data associated browsing history of a customer. The recommendation engine 102 may train one or more models using the historical data of the customer. The one or more models may be trained to generate cohesive product recommendations and variants for a specific customer. The one or more models may be trained to generate cohesive product recommendations to the customer based on an initial product interacted with by the customer (e.g., anchor item). In some embodiments, the one or more models are configured to receive feedback from the customer to refine or retrain the one or more models. For example, a customer may purchase one or more recommended products of the same cohesive look thereby indicating that the products associated with that look are cohesive and match. A customer may indicate that one or more products of a look are not cohesive and do not match. This indication may be inputted into the one or more models to refine the one or more models regarding this specific look.

In some embodiments, the outputs from the model may be used to refine and train the model. For example, one or more models may be trained using historical data (e.g., historical transaction data of the customer) and may generate a plurality of recommended products in various product types for the customer. Recommendation engine 102 may receive purchase data associated with whether the customer purchased the one or more of the recommended products (e.g., purchased products). The purchase data, including the purchased products, may be inputted into the one or more models such that the one or more models compares the purchased products to the recommended products to generate a comparison value. The greater the comparison value the greater the deviation the purchased product is from the recommended products. In other words, the greater the comparison value, the less accurate the one or more models is. In some embodiments, the comparison value may be inputted into the one or more models to refine the one or more models to make the one or more models more accurate.

The models, when executed by the recommendation engine 102, allow the recommendation engine 102 to generate a plurality of recommended products in various product types for the customer. In some examples, the recommendation engine 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, the recommendation engine 102 may generate a plurality of recommended products in various product types for the customer. Recommendation engine 102, using one or more models, may generate one or more looks or sets (e.g., sets or groups of products) based on the plurality of recommended products and prioritize the one or more looks based on the customer's historical transaction data. The recommendation engine 102 may provide a user interface to allow a user to interact with the recommended products and the one or more looks. For example, the user interface may allow a user to view and interact with the recommend products associated with one or more looks to purchase one or more of the recommended products.

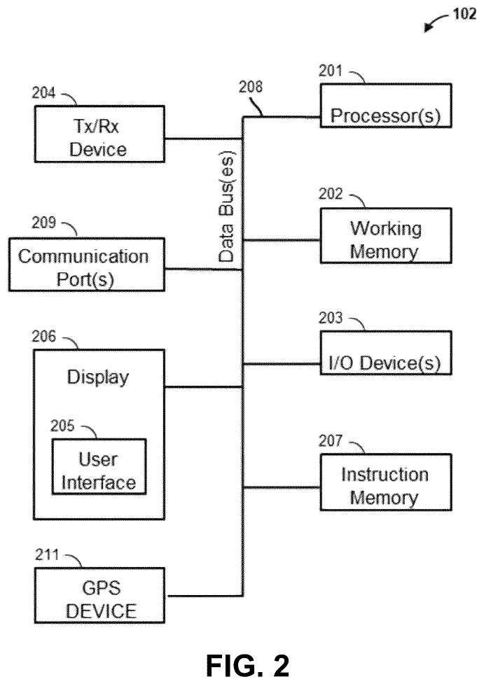

FIG. 2 illustrates a block diagram of a recommendation engine, e.g. the recommendation engine 102 of FIG. 1, in accordance with some embodiments of the present teaching. In some embodiments, each of the recommendation engine 102, the web server 104, the multiple user computing devices 110, 112, 114, and the one or more processing devices 120 in FIG. 1 may include the features shown in FIG. 2. Although FIG. 2 is described with respect to certain components shown therein, it will be appreciated that the elements of the recommendation engine 102 can be combined, omitted, and/or replicated. In addition, it will be appreciated that additional elements other than those illustrated in FIG. 2 can be added to the recommendation engine 102.

As shown in FIG. 2, the recommendation engine 102 can include one or more processors 201, an instruction memory 207, a working memory 202, one or more input/output devices 203, one or more communication ports 209, a transceiver 204, a display 206 with a user interface 205, and an optional location device 211, all operatively coupled to one or more data buses 208. The data buses 208 allow for communication among the various components. The data buses 208 can include wired, or wireless, communication channels.

The one or more processors 201 can include any processing circuitry operable to control operations of the recommendation engine 102. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 can be configured to perform a certain function or operation by executing code, stored on the instruction memory 207, embodying the function or operation. For example, the one or more processors 201 can be configured to execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that the recommendation engine 102 can include a single memory unit configured to operate as both instruction memory and working memory. Further, although embodiments are discussed herein including non-volatile memory, it will be appreciated that computing device 110, 112, 114 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 201.

The input-output devices 203 can include any suitable device that allows for data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 allow for communication with a network, such as the communication network 118 of FIG. 1. For example, if the communication network 118 of FIG. 1 is a cellular network, the transceiver 204 is configured to allow communications with the cellular network. In some embodiments, the transceiver 204 is selected based on the type of the communication network 118 the recommendation engine 102 will be operating in. The one or more processors 201 are operable to receive data from, or send data to, a network, such as the communication network 118 of FIG. 1, via the transceiver 204.

The communication port(s) 209 may include any suitable hardware, software, and/or combination of hardware and software that is capable of coupling the recommendation engine 102 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 allows for the programming of executable instructions in the instruction memory 207. In some embodiments, the communication port(s) 209 allow for the transfer (e.g., uploading or downloading) of data, such as machine learning model training data.

In some embodiments, the communication port(s) 209 are configured to couple the recommendation engine 102 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 are configured to utilize one or more communication protocols. Examples of wired protocols can include, but are not limited to, Universal Serial Bus (USB) communication, RS-232, RS-422, RS-423, RS-485 serial protocols, Fire Wire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 206 can be any suitable display, and may display the user interface 205. For example, the user interfaces 205 can enable user interaction with the recommendation engine 102 and/or the web server 104. For example, the user interface 205 can be a user interface for an application of a network environment operator that allows a customer to view and interact with the plurality of recommended products generated by the recommendation engine 102. In some embodiments, a user can interact with the user interface 205 by engaging the input-output devices 203. In some embodiments, the display 206 can be a touchscreen, where the user interface 205 is displayed on the touchscreen.

The display 206 can include a screen such as, for example, a Liquid Crystal Display (LCD) screen, a light-emitting diode (LED) screen, an organic LED (OLED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device configured to receive position data identifying a latitude and longitude from one or more satellites of a GPS constellation. As another example, in some embodiments, the location device 211 is a cellular device configured to receive location data from one or more localized cellular towers. Based on the position data, the recommendation engine 102 may determine a local geographical area (e.g., town, city, state, etc.) of its position.

In some embodiments, the recommendation engine 102 is configured to implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software.

In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

The network environment 100 further includes one or more model training systems that are communicatively coupled with at least one or more model database maintaining trained models and one or more training data databases (e.g., database 116) that stores relevant training data to train and/or retrain the one or more models used by the recommendation engine 102. The model training system includes one or more model training servers or managers, which are implemented through one or more computing systems, servers, computers, processor and/or other such systems communicatively coupled with one or more of the distributed communication networks 118, and are configured to build and/or train the machine learning models. In some implementations, the model training system includes multiple sub-model training systems each associated with one or more of the different machine learning models.

The training data database stores and updates relevant training data. The training data may include historical data of customers. Further, the training data includes historic sales data (e.g., of the recommended products), typically for one or more years, in association with historic inventory information, historic marketing information, and other such information. The training data additionally includes historic information about different information supplied to and/or accessed by different users corresponding to thousands or more products from hundreds of different suppliers and/or manufactures and sold from multiple different retail stores distributed over multiple different geographic areas. Further, the training systems is configured to receive feedback information at least through the graphical user interface. This feedback can include changes in settings, requests for other information, clicks to other information, clicks to more detailed information, tagging of information for another potential recipient, indications of like and/or dislike of information, comments, actions indicating a disregard of types of information, searches performed, subsequent use of information provided, subsequent actions taken by recipients following access to different information, and other such feedback. The training system utilizes the feedback information to repeatedly over time retrain the models to repeatedly provide over time retrained models to provide more accurate recommended products and prioritization of the recommended products to the customer. This allows the models to be refined per customer to provide recommended products that the customer has a high likelihood of purchasing.

The training data databases (e.g., database 116) can be local to the model training system, remote and accessible over one or more of the communication networks 118 or a combination of local and distributed. The model training system uses the relevant machine learning data to train the machine learning models. In some embodiments, one or more training processes are similar to the process performed by one or more models after having been trained, but can be trained with multiple sets of training data (e.g., some real and some simulated or synthetic for training). Predictions are compared to actuals to ensure that the set of models are operating with a certain threshold confidence. Further, the model training system is configured to receive feedback information through the graphical user interface corresponding to actions by the recipient interfacing with the graphical user interface.

The above and below description includes descriptions of embodiments implementing and/or utilizing trained machine learning models and/or neural networks. In some embodiments, the neural network, machine learning models and/or machine learning algorithms may include, but are not limited to, Large Language Models (LLM), Heuristics, Univariate based techniques, Multivariate, control limit, isolation forest and LOF-ensembles, deep learning models such as LSTM-based autoencoders, variational autoencoders, deep stacking networks (DSN), Tensor deep stacking networks, convolutional neural network, probabilistic neural network, autoencoder or Diabolo network, linear regression, support vector machine, Naïve Bayes, logistic regression, K-Nearest Neighbors (kNN), decision trees, random forest, gradient boosted decision trees (GBDT), K-Means Clustering, hierarchical clustering, DBSCAN clustering, principal component analysis (PCA), and/or other such models, networks and/or algorithms.

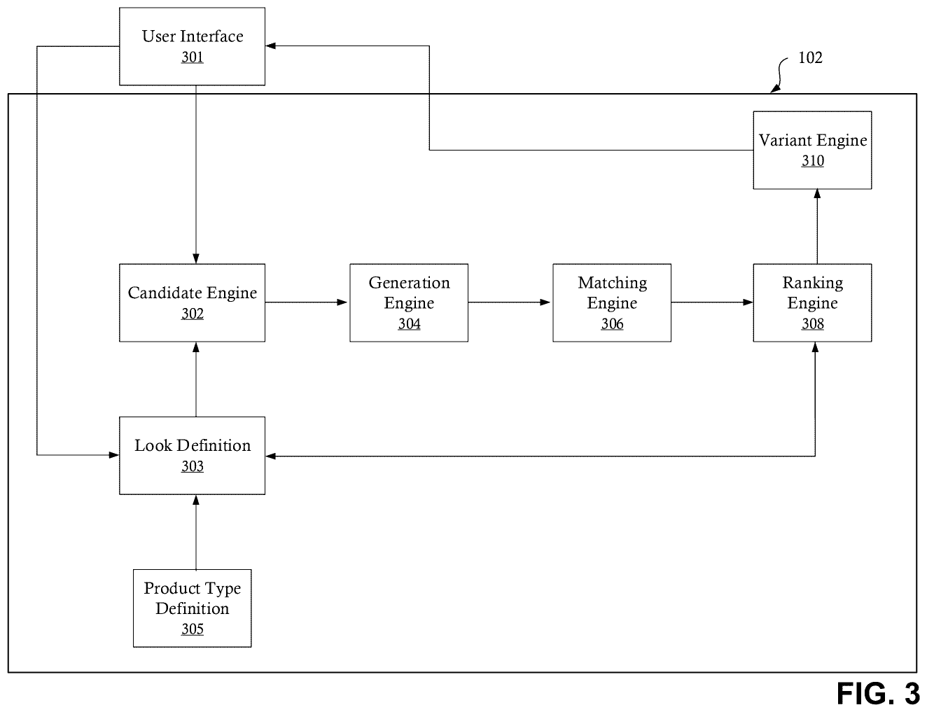

FIG. 3 is a flow diagram of recommendation engine 102, in accordance with some embodiments of the present teaching. As indicated in FIG. 3, recommendation engine 102 may include candidate engine 302, generation engine 304, matching engine 306, ranking engine 308, and variant engine 310. Candidate engine 302 may be configured to be in communication with user interface 301 (e.g., a user interface of an electronic device associated with a customer). Candidate engine 302 may receive interaction data from user interface 301. In practice, a customer interacts with an anchor product using user interface 301. The anchor product may be transmitted to candidate engine 302.

In some embodiments, recommendation engine 102 is coupled to database 116 and candidate engine 302 receives interaction data and/or historical customer data from database 116. The historical customer data may be associated with a specific customer. In some embodiments, recommendation engine 102 is configured to tag the historical customer data with a customer identifier associated with the customer. Recommendation engine 102 may be configured to map the customer identifier to the historical customer data to link the historical customer data to the customer. In some embodiments, historical customer data includes customer demographics, customer profiles, transactions of customers, purchase history, delivery history, billing history, viewing history, browsing features, and customer interactions with an e-commerce platform of the retailer.

The customer may access website of a retailer hosted on an e-commerce platform. The customer may interact with and view one or more products offered by the retailer. The customer may select one product (e.g., via click) and that product is assigned an anchor indicator designated that product as the anchor product or anchor item. The selection of the anchor product by the customer may be transmitted to recommendation engine 102 (e.g., candidate engine 302). In some embodiments, user interface 301 transmits the anchor product to candidate engine 302. In alternative embodiments, candidate engine 302 may receive the anchor product from database 116, which received the anchor product within interaction data from user interface 301.

Candidate engine 302 may be configured to generate complimentary product data based on a customer's selection of an anchor product. For example, in response to a customer's selection of an anchor product, candidate engine 302 may parse catalog data within database 116 and identify complimentary product data including a plurality of complimentary product types associated with the anchor product. In some embodiments, each product type of product data includes one or more anchor indicators mapping/linking the product type to one or more anchor products. The mapping/linking may be determined based on previous transactions, views, or prior generated cohesive looks. Candidate engine 302 may transmit complimentary product type data including the plurality of complimentary product types to generation engine 304.

Generation engine 304 may be configured to generate look data including one or more looks based on the complimentary product types received from candidate engine 302. For example, generation engine 304 may identify one product each from a plurality of product types to generate a look. Each look may include products from different product types to form an overall look or outfit. Generation engine 304 may transmit the one or more looks to matching engine 306.

Matching engine 306 may be configured to evaluate visual similarities between the plurality of products within each look to generate cohesive look data including a plurality of cohesive looks or outfits. For example, matching engine 306 may utilize one or more models to evaluate and compare visual similarities between products within each look to determine whether the products are cohesive. In some embodiments, matching engine 306 is configured to replace one product with a different product from the same product type that has a visual similarities to the other products within the look such that all the products within the look are cohesive. All the products within the look being cohesive results in a cohesive look. Matching engine 306 may utilizes one or more models for a plurality of looks to generate a plurality of cohesive looks. In some embodiments, matching engine 306 transmits the cohesive look data (e.g., one or more cohesive looks) to ranking engine 308.

Matching engine 306 may transmit the cohesive look data including one or more cohesive looks to ranking engine 308, which is configured to prioritize the cohesive looks. For example, ranking engine 308 may assign weights to each of the cohesive looks and may present to the customer the highest weighted cohesive look. Ranking engine 308 may transmit the one or more of the highest weighted cohesive looks to user interface 301 for display to the customer. The customer may interact with the one or more cohesive looks provided by ranking engine 308.

Ranking engine 308 may receive the cohesive look data from matching engine 306 and prioritize the cohesive looks. For example, ranking engine 308 may prioritize the cohesive looks based on historical customer data associated with the customer. Ranking engine 308 may transmit the prioritized cohesive looks to variant engine 310. Variant engine 310 may be configured to generate one or more variant cohesive looks based on the prioritized cohesive looks. The variant cohesive looks may include a different initial product (e.g., anchor product). Variant engine 310 may replace the anchor product initially selected by the customer with a supquent anchor product identified by variant engine 310. For example, for each cohesive look, variant engine 310 may replace the anchor product with a subsequent anchor product to generate variant cohesive looks. The subsequent anchor product may be visually similar to the anchor product. Variant engine 310 may transmit the cohesive looks and the variant cohesive looks to user interface 301 for displaying to the customer.

In some embodiments, user interface 301 receives input from a customer in response to being presented the cohesive looks and/or the variant cohesive looks. The input from the customer may be used to refine and/or retrain one or more models used to generate the cohesive looks and/or the variant cohesive looks.

With continued references to FIG. 3, candidate engine 302 may be configured to identify products that are candidates for a cohesive look or outfit. In some embodiments, candidate engine 302 utilizes one or more models to identify one or more product types (e.g., clothing products) that are complimentary and compatible with each other and the anchor product (e.g., complimentary product types). For example, candidate engine 302 may utilize one or more models to identify product type data associated with product types that are purchased, viewed, or interacted with together. Candidate engine 302 may be configured to identify complimentary product type data include a set of complimentary product types for each anchor product. For example, for each anchor product provided by retailer, candidate engine 302 may identify a set of product types that are complimentary to the anchor product. By way of an example, for an anchor product of a blue shirt, candidate engine 302 may generate a set of product types include a product type of pants, shoes, outwear, and/or jewelry. In some embodiments, each product type is associated with one or more anchor products (via an anchor indicator). Candidate engine 302 may parse each product type for the anchor indicator associated with the anchor product to identify one or more complimentary product types.

Candidate engine 302 may be configured to receive information from a user interface associated with a customer's device (e.g., user interface 301). In some embodiments, a customer utilizes user interface 301 to view and interact with one or more products and may select one product (e.g., anchor product) for further information or purchase. Interaction data may be transmitted from user interface 301 to candidate engine 302. The interaction data may include interactions of the customer on a website or e-commerce platform. In some embodiments, the interaction data includes an anchor item. The anchor item may be a product that the customer is interacting with, viewing, or has added to their cart. In some embodiments, user interface 301 transmits the interaction data to database 116 for storage. The interaction data may be associated with a customer ID of the customer such that the customer is linked and associated with the interaction data pertaining to their interactions on the website. The interaction data may include customer historical data. Candidate engine 302 may receive the interaction data from user interface 301 and/or database 116 and may identify an anchor item.

In some embodiments, candidate engine 302 receives looks definition 303. Look definition 303 may be stored within database 116 and may include one or more looks based on a plurality of product types. Look definition 303 may include a plurality of looks defined by a combination of different product types. In some embodiments, look definition 303 is generated using product type (PT) definition 305. PT definition 305 may include a super product type that is narrowly defined and a subset of a product type. In some embodiments, each product type includes a plurality of super products. For example, each product within a super product type may be a product that shares a function or feature with other products in the super product type. In some embodiments, a product type may have a plurality of super product type subsets. For example, a product type of outwear may include a super product type of raincoat, poncho, hoodie, rain jacket, etc. PT definition 305 may include a recall function to super product type data associated with the super product types. The super product type data may be stored within database 116 and may be used by look definition 303. For example, look definition 303 may include a plurality of products, each from a different super product type to form a look or outfit. Look definition 303 may include first look which may include first product from a first super product type, a second product from a second super product type, and a third product from a third product type. Each look may include products from a plurality of different super product types. For example, each look may be a combination of products from different super product types. Each look may include a plurality of products each from a different super product type. In some embodiments, each look does not include two products from the same super product type.

In some embodiments, look definition 303 is updated or modified based on feedback from a customer. For example, a customer may user interface to adjust looks presented to the customer. A look receiving negative feedback or little positive feedback may be removed or modified. In some embodiments, a look (e.g., combination of products within different super product types) that receives negative feedback or little positive feedback is altered such one or more products are replaced with another product from the same product type or super product type. Look definition 303 may be modified or updated based on one or more external sources. For example, look definition 303 may be updated based on data received by recommendation engine 102 from third party sources (e.g., fashion blogs, fashion magazines, fashion experts).

In some embodiments, the anchor product selected by the customer determines the set of complimentary product types identified by candidate engine 302. For example, based on the customer interacting with an anchor product, candidate engine 302 may identify a set of complimentary product types. In some embodiments, a weight is applied to each product type in the set of complimentary product types for each anchor product. For a given anchor product, if recommendation engine 102 does not receive positive feedback regarding the generated look, a low weight value (e.g., less than 0.5) may be assigned to the set of complimentary product types associated with the anchor product.

Candidate engine 302 may parse product data or catalog data stored within database 116 to extract complimentary product types. For example, database 116 may include product data and/or catalog data associated with a plurality of products and a plurality of product types. Candidate engine 302 may be configured to parse the product data and using one or more models to identify product types that are complimentary to the anchor product.

In some embodiments, candidate engine 302 receives historical customer data associated with a plurality of customers. The historical customer data may include transaction data identifying product types that were frequently bought together. Candidate engine 302 may utilize one or more models and the historical customer data to generate product types that are complimentary to an anchor item selected by a customer.

In some embodiments, candidate engine 302 is configured to apply one or more filters to the plurality of products within each complimentary product type. For example, candidate engine 302 may filter out (e.g., remove) products with each complimentary product type based on age, gender, season, popularity, and/or size. In some embodiments, candidate engine 302 filters out inappropriate or controversial products from the plurality of products within each complimentary product type.

In some embodiments, candidate engine 302 is configured to transmit the complimentary product type data including the set of complimentary product types (or super product types) to generation engine 304. Generation engine 304 may be configured to generate look data including a plurality of looks/outfits using a plurality of products from the plurality of complimentary product types or super product types received from candidate engine 302. In some embodiments, generation engine 304 receives the set of complimentary product types and utilizes one or more models to generate a plurality of looks. The plurality of looks may be dependent on the anchor product selected by the customer.

Each look may be a combination of products of different product types or super product types, as described below. For example, a look generated by generation engine 304 may include a first product of a first product type (e.g., long sleeved shirt), a second product of a second product type (e.g., blue jeans), a third product of a third product type (e.g., rain jacket), a fourth product of a fourth product type (e.g., white sneakers), and a fifth product of a fifth product type (e.g., a dark brown leather wallet). The combination of the first product, second product, third product, fourth product, and fifth product may form a look. Generation engine 304 may generate a different looks using a combination of different products of different product types. A look may include two products, three products, four products, five products, or greater than five products. In some embodiments, a look includes a plurality of products each of a different product type. Upon generating a look, generation engine 304 may transmit the look to matching engine 306. The look generated by generation engine 304 may include complimentary products of different product types.

In some embodiments, a one or more looks generated by generation engine 304 are not visually cohesive or matching. For example, generation engine 304 may receive complimentary product type data from candidate engine 304 and the complimentary product type data may include candidates for a cohesive look. The candidates may be dependent on the anchor product selected by the customer. The candidates may be combination of products from different product types or super product types. In some embodiments, generation engine 304 generates one or more looks (e.g., look data) based on the candidates (e.g., products from different product types or super product types). The one or more looks (e.g., look data) generated by generation engine 304 may include complimentary products of different products that do not form a cohesive look. For example, a look generated by generation engine 304 may include a brown dress shirt, black sweat pants, a yellow belt, and sandals. These products together do not form a cohesive look based one or more rules stored within database 116.

In some embodiments, database 116 includes one or more rules that include fashion trends, fashion rules, color matching rules, and other rules pertaining to identifying cohesive looks. The one or more rules may be related to design or fashion to allow for color matching and providing a cohesive look. The one or more rules may also include trends such as fashion trends or design trends to allow generation engine 304 to generate cohesive looks. One or more rules may be generated based on input from one or more sources. For example, recommendation engine 102 may query third party databases to identify current trends and popular products and may generate rules based on the query and store the rules within database 116. In some embodiments, recommendation engine 102 receives one or more rules from one or more individuals. For example, a fashion blogger or fashion designer may provide one or more rules to recommendation engine 102, which may store the one or more rules with database 116.

In practice, generation engine 304 receives the complimentary product type data including the set of complimentary product types associated with the anchor product from candidate engine 302. Generation engine 304 may identify one or more products within each complimentary product type to generate a look. In some embodiments, generation engine 304 generates look data, including a plurality of looks, based on the one or more products within each complimentary product type. Due to each complimentary product type having a plurality of different products, generation engine 304 generates a plurality of looks based on different combinations of the different products within the set of complimentary product types. As described above, one or more of the plurality of looks may not be visually cohesive (e.g., may not match or abide by the one or more rules).

In some embodiments, generation engine 304 transmits the look data containing the plurality of looks associated with the anchor product to matching engine 306. Matching engine 306 may be configured to identify one or more looks from look data that are visually cohesive. In some embodiments, matching engine 306 is configured to evaluate visual similarities between products of different product types within a look. Matching engine 306 may use one or more models to evaluate visual similarities between products of different product types within a look. For example, matching engine 306 may utilize a supervised learning model or algorithm to evaluate visual similarities between products of different product types within a look. The one or more models may be trained using historical customer data. The historical customer data may include products that have been purchased or viewed together to train the one or more models to evaluate visual similarities. Visual similarities between products may include products that provide visual coherence and consistency.

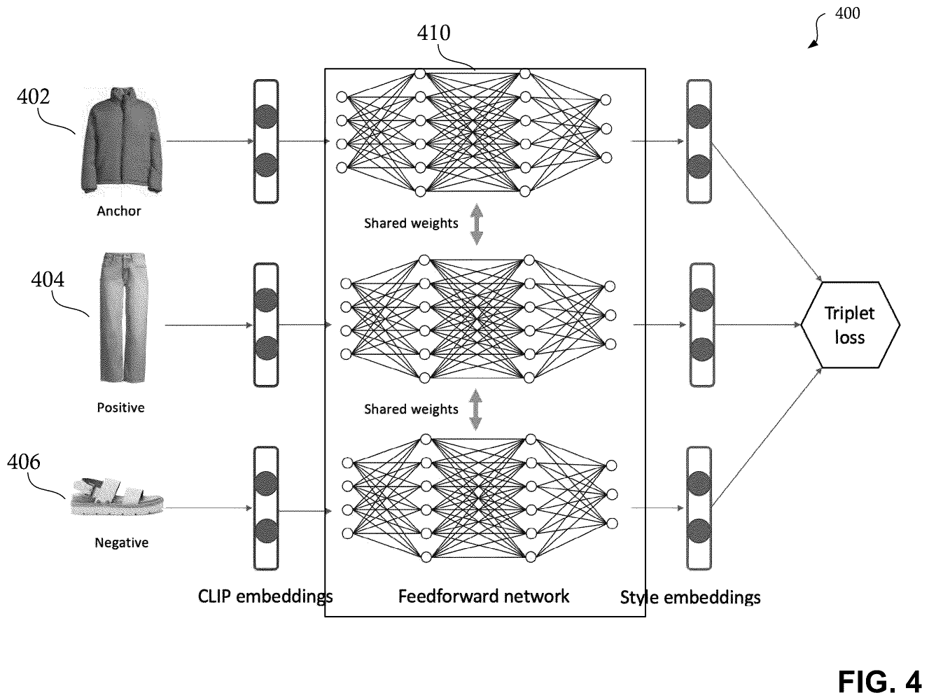

FIG. 4 illustrates exemplary training of model 400 utilized by recommendation engine 102, such as matching engine 306. In some embodiments, model 400 is trained to determine whether a look is visually cohesive. Model 400 may receive a plurality of products as inputs. In some embodiments, the inputs include anchor input 402, positive input 404, and negative input 406, each being a different product of a different product type. Model 400 may be trained using triplet learning configured to receive a triplet of products as input and outputting a high value for the positive input and a low value for the negative product relative to the anchor input 402. Model 400 may use image embeddings 408 associated with each of anchor input 402, positive input 404, and negative input 406. Image embeddings of anchor input 402, positive input 404, and negative input 406 may be used as the inputs into model 400. Image embeddings of the inputs may be generated using a neural network such as contrastive language-image pre-training (CLIP).

In some embodiments, image embeddings of the input are generated using one or more models to identify images that include only the desired product. For example, one or more images of the desired product may include other products or items in the image or may include the product being worn by an individual. The one or more models used to generate the image embeddings may be configured to identify “laid-down” images of the desired product. The “laid-down” images may not include other products (e.g., non-desired products) and may not include limbs or other human parts. The one or more models used to generate the image embeddings may first identify product images with human limbs and, second, use a classifier to score and select the best images where no human is present.

Anchor input 402 may be an anchor product selectable by a customer and to determine other products that provide a cohesive look with anchor input 402. Positive input 404 may a product that is identified as being visually cohesive with anchor input 402. Positive input 404 may be identified based on being previously purchased or viewed with anchor input 402. For example, positive input 404 may be from the same look as anchor input 402. Negative input 406 may be a product from a different look than anchor input 402 and positive input 404. In some embodiments, anchor input 402 and positive input 404 are part of the same look and are identified based on a merchant and/or customer interactions (e.g., viewing, purchasing, or adding-to-cart anchor input 402 and positive input 404 together).

In some embodiments, model 400 is trained by inputting image embeddings of anchor input 402, positive input 404, and negative input 406 into network 410. Network 410 may be a feedforward neural network. Network 410 may output a high value for positive input 404 and a low value for negative input 406. Model 400 may be configured to utilize network 410 with triplet loss to train product-style embeddings. Model 400 may be trained using a plurality of inputs selected from a dataset containing a plurality of looks. In some embodiments, model 400 uses style embeddings to further refine a look by selecting products that are visually similar in the embedding space.

Model 400 may be utilized by matching engine to identify whether a product within a look is visually cohesive and matching with the anchor product of the same look. In some embodiments, a look permutation step may be implemented to increase the coverage of the one or more models (e.g., model 400) used to identify cohesive looks. For example, for a look having a t-shirt as the anchor product, a pair of jeans may be selected as a product providing a cohesive look with the t-shirt. Matching engine 306 may link the t-shirt to the pair of jeans such that when the pair of jeans are selected as the anchor product, the t-shirt will be selected as a product that provides a cohesive look with the pair of jeans. The look permutation step may be performed for all or some anchor products. For example, the look permutation step may be performed for anchor products associated with upper-body and lower-body apparel, but not for shoes and other accessories.

With reference to FIGS. 3 and 4, matching engine 306 may utilize one or more models, such as model 400, to generate cohesive look data. The cohesive look data may include one or more cohesive looks associated with the anchor product selected by the customer. A cohesive look may include a plurality of products each form a different product type (or super product type) that is visually cohesive and similar to the anchor product of the cohesive look. In some embodiments, matching engine 306 is configured to adjust cohesive looks based on preferences of the customer. Matching engine 306 may receive preferences of the customer, such as age, gender, size, color preferences, etc., and may adjust cohesive looks based on the preferences. For example, matching engine 306 may adjust or remove cohesive looks that include products that are not the correct size of the customer. In some embodiments, a customer may utilize an e-commerce platform to add one or more products to an initial basket. Recommendation engine 102 may analyze the historical customer data associated with the customer and may identify affinities/preferences associated with the customer. Recommendation engine 102 may store the affinities/preferences as historical customer data within database 116.

Matching engine 306 may transmit the cohesive look data to ranking engine 308. Ranking engine 308 may be configured to prioritize each cohesive look of the cohesive look data based on how well each product within each cohesive look matches the anchor product of cohesive look and other products within the cohesive look. Ranking engine 308 may apply weights (e.g., values between 0 and 1) based on one or more features between the products within a given cohesive look. The features may be determined via product data associated with each product of a cohesive look.

The product data may be retrieved from database 116 by ranking engine 308. For example, for a given cohesive look, ranking engine 308 may analyze how close the prices of each products, how similar the brands are, and are compatible the colors are. Ranking engine 308 may apply weights to the cohesive look based on each feature (e.g., price proximity, brand proximity, and color compatibility). For example, if the price between products within a cohesive look are similar, then the cohesive look will be given a higher weight. By way of another example, if the color of products within a cohesive look are not compatible, then the cohesive look will be given a lower weight. In some embodiments, the weights are adjusted based on a customer's interaction with a cohesive look. Ranking engine 308 may prioritize the cohesive looks generated by matching engine 306 based on the applied weights. The cohesive looks with the highest weights may be prioritized over the cohesive looks with the lower weights.

Ranking engine 308 may be configured to receive historical customer data associated with a customer and determine affinities/preferences of the customer. For example, based on prior transactions of the customer, ranking engine 308 may identify a brand affinity, color affinity, size affinity, gender affinity, price affinity, etc. The affinities of the customer may indicate preferences of the customer that would result in a high likelihood of the customer purchasing a specific product from a look.

In some embodiments, ranking engine 308 applies weights to the cohesive looks based on look definition 303. For example, ranking engine 308 may receive look definition 303 and prioritize the cohesive looks based on look definition 303. Ranking engine 308 may transmit the prioritized cohesive looks to variant engine 310. Variant engine 310 may be configured to generate variant cohesive looks based on the prioritized cohesive looks. In some embodiments, variant engine 310 is configured to replace an anchor product of a cohesive look with a similar product to generate a new variant cohesive look. In some embodiments, variant engine 310 generates a new variant cohesive look based on other non-anchor products within the cohesive look. For example, a cohesive look may include an anchor product, a first product, and a second product. Variant engine 310 may determine that the first product and the second product have been associated with one or more other subsequent anchor products and thus may generate variant cohesive looks based on the subsequent anchor products.

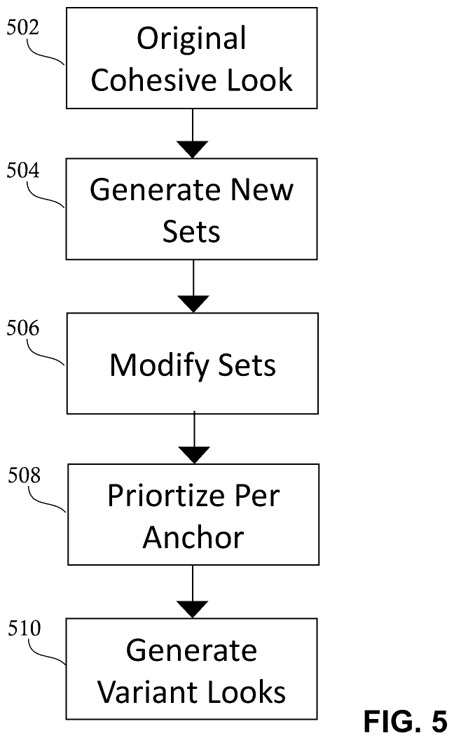

FIG. 5 illustrates an exemplary flow diagram of variant engine 310. At operation 502, variant engine 310 is configured to receive the cohesive look from ranking engine 308. At operation 504, variant engine 310 may be configured to generate a set of new proposed variant looks based on taking cohesive looks generated by generation engine 304 and prioritized by ranking engine 308, and replacing the anchor product of each cohesive look. In some embodiments, at operation 504, variant engine 310 may implement a visual search (e.g., an embedding-based search) in which product images are mapped to an embedding using one or more models (e.g., CLIP). Variant engine 310 may utilize one or more models (e.g., Faiss or ScaNN) to find similar product images in the embedding space.

At operation 506, variant engine 310 may modify the set of new proposed variant looks by removing looks that do have non-compatible products and may generate modified proposed variant looks based on the modifications. For example, one or more proposed variant looks may include products designed for a different gender, having the wrong size, or being outside the desired price range of the customer. At operation 508, variant engine 310 may be configured to prioritize the modified proposed variant looks for every anchor product based on similarity to the original anchor. For example, a modified proposed variant look that has a vastly different style, size, or color compared to the original anchor of the original cohesive look may be removed or adjusted.

In some embodiments, variant engine 310 prioritizes modified proposed variant look that include one or more products that are determined to be popular. Similar to ranking engine 308, variant engine 310 may apply one or more weights to modified proposed variant looks to prioritize modified proposed variant looks that are popular or close to preferences of the customer. At operation 510, variant engine 310 may generate cohesive variant looks that provide the customer with an expanded look compared to the cohesive look. Variant engine 310 may transmit the cohesive looks and the variant cohesive looks to user interface 301. User interface 301 may be configured to display the cohesive looks and the variant cohesive looks to the customer.

In some embodiments, user interface 301 receives interaction data that the customer has selected one or more products from a cohesive look or variant cohesive look for purchase and transmits that interaction data to database 116. The interaction data may be used by recommendation engine 102 to train, re-train, and/or refine one or more models used by recommendation engine 102. In some embodiments, user interfaces 301 and 205 are the same. For example, user interface 301 and 205 may be the user interface of the same electronic device. Alternatively, user interface 301 may be associated with the customer and user interface 205 is associated with a retailer. The retailer may host a website with which the customer interacts with through user interface 301.

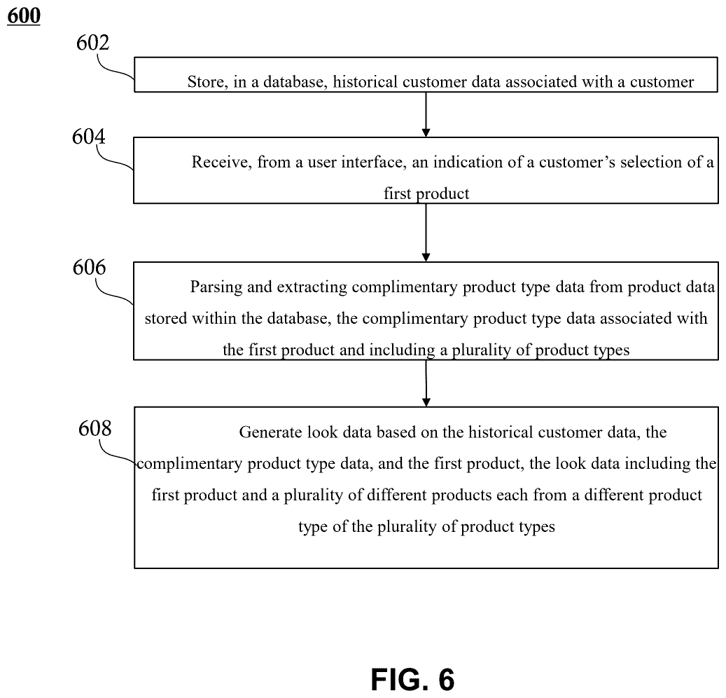

FIG. 6 is a flowchart illustrating an exemplary method for generating cohesive product recommendation sets and variants. At operation 602, recommendation engine 102 stores historical customer data within database 116. Recommendation engine 102 may receive historical customer data from an electronic device or user interface associated with the customer. The historical customer data may include interaction data associated with the customer's interaction with an e-commerce platform of a retailer. At operation 604, recommendation engine 102 may receive an indication of a customer's selection of a first product (e.g., an anchor product). The customer may be selecting the first product to add to a cart for purchase or may be viewing additional information about the first product. Upon selection of the first product, recommendation engine 102 may be configured to parse product data for information pertaining complimentary product type data associated with the first product. Recommendation engine 102 may extract complimentary product type data based on parsing product data containing various product types. The various product types may include one or more anchor indicators associating the product type with one or more anchor products. At operation 606, recommendation engine 102 may generate look data based on the historical customer data, the complimentary product type data, and the first product, the look data including the first product and a plurality of different products each from a different product type of the plurality of product types. The look data may include one or more cohesive looks including a plurality of products each from a different product type. The cohesive looks may include a plurality of products each being visually cohesive and compatible. In some embodiments, recommendation engine 102 utilizes one or more models to generate a plurality of cohesive looks.

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a processor; and
a non-transitory memory storing instructions, that when executed, cause the processor to:
store, in a database, historical customer data associated with a customer;
receive, from a user interface, an indication of a customer's selection of a first product;
parse and extract complimentary product type data from product data stored within the database, the complimentary product type data associated with the first product and including a plurality of product types; and
generate look data based on the historical customer data, the complimentary product type data, and the first product, the look data including the first product and a plurality of different products each from a different product type of the plurality of product types.

2. The system of claim 1, wherein the instructions cause the processor to:
generate cohesive look data, by a machine learning model, the cohesive look data including one or more cohesive looks, wherein the machine learning model compares visual similarities between each different product from the plurality of different products.

3. The system of claim 2, wherein the machine learning model is a large language model.

4. The system of claim 2, wherein the instructions further cause the processor to:
transmit the cohesive look data to a ranking engine, wherein the ranking engine is configured to:
assign weights to each of the one or more cohesive looks;
transmit one or more of the highest weighted cohesive looks to a user interface for display to the customer.

5. The system of claim 1, wherein the instructions further cause the processor to:
replace the customer's selection of the first product with a second product, by a variant engine, wherein the second product is visually similar to the first product; and
generate look data based on the historical customer data, the complimentary product type data, and the second product, the look data including the second product and a plurality of different products each from a different product type of the plurality of product types.

6. The system of claim 1 wherein the product types include a plurality of super products types, wherein each super product type is a subset of a product type.

7. The system of claim 6, wherein the look data includes a plurality of products from each of the plurality of super product types.

8. The system of claim 6, wherein the instructions further cause the processor to:
receive feedback of a look from a customer;
replace one or more products of the plurality of different products with another product from the same product type or the super product type.

9. A method comprising:
storing, in a database, historical customer data associated with a customer;
receiving, from a user interface, an indication of a customer's selection of a first product;
parsing and extracting complimentary product type data from product data stored within the database, the complimentary product type data associated with the first product and including a plurality of product types; and
generating look data based on the historical customer data, the complimentary product type data, and the first product, the look data including the first product and a plurality of different products each from a different product type of the plurality of product types.

10. The method of claim 8, further comprising:
generating cohesive look data, by a machine learning model, the cohesive look data including one or more cohesive looks, wherein the machine learning model compares visual similarities between each different product from the plurality of different products.

11. The method of claim 10, wherein the machine learning model is a large language model.

12. The method of claim 9, further comprising:
transmitting the cohesive look data to a ranking engine, wherein the ranking engine is configured to:
assigning weights to each of the one or more cohesive looks;
transmitting one or more of the highest weighted cohesive looks to a user interface for display to the customer.

13. The method of claim 8, the method further includes:
replacing the customer's selection of the first product with a second product, by a variant engine, wherein the second product is visually similar to the first product; and
generating look data based on the historical customer data, the complimentary product type data, and the second product, the look data including the second product and a plurality of different products each from a different product type of the plurality of product types.

14. The method of claim 8, wherein the product types include a plurality of super products types, wherein each super product includes a subset of a product type.

15. The method of claim 12, wherein the look data includes a plurality of products from each of the plurality of super product types.

16. The method of claim 8, further includes:
receiving feedback of a look from a customer;
replacing one or more products of the plurality of different products with another product from the same product type or the super product type.

17. A non-transitory computer readable medium having instructions stored thereon, wherein the instructions, when executed by at least one processor, cause at least one device to perform operations comprising:
storing, in a database, historical customer data associated with a customer;
receiving, from a user interface, an indication of a customer's selection of a first product;
parsing and extracting complimentary product type data from product data stored within the database, the complimentary product type data associated with the first product and including a plurality of product types; and
generating look data based on the historical customer data, the complimentary product type data, and the first product, the look data including the first product and a plurality of different products each from a different product type of the plurality of product types.

18. The non-transitory computer readable medium of claim 15, wherein the instructions cause the at least one device to:
generating cohesive look data, by a machine learning model, the cohesive look data including one or more cohesive looks, wherein the machine learning model compares visual similarities between each different product from the plurality of different products.

19. The non-transitory computer readable medium of claim 18, wherein the instructions cause the at least one device to:
replacing the customer's selection of the first product with a second product, by a variant engine, wherein the second product is visually similar to the first product; and
generating look data based on the historical customer data, the complimentary product type data, and the second product, the look data including the second product and a plurality of different products each from a different product type of the plurality of product types.

20. The non-transitory computer readable medium of claim 18, wherein the instructions cause the at least one device to:
receive feedback of a look from a customer;
replace one or more products of the plurality of different products with another product from the same product type or the super product type.
